(19) United States
(12) Patent Application Publication
(10) Pub. No.: US 2005/0279008 A1
(43) Pub. Date: Dec. 22, 2005

(54) Armband fishing pole holder

(76) Inventor: Rolando Hernandez, Vancouver, WA (US)

Correspondence Address: K.M. RYLANDER TRIAL;PATENT ATTORNEY AT LAW PC, Suite 206, 1014 Franklin Street, Vancouver, WA, 98660, US

(21) Appl. No.: 10/873,611

(22) Filed: Jun. 21, 2004

(51) Int. Cl. A01K 97/10

(52) U.S. Cl. 43/21.2

(57) ABSTRACT

An armband fishing pole holder for stabilizing a fishing pole in use or while traveling on an individual includes a strap which encircles the arm of an individual; and a hook attached to said strap. The holder can further include a fastening loop at one end of the strap. The holder can be provided with a buckle on end of the strap and hook and fastener material on an opposite end of the strap. The hook can be position on the holder to curve in the direction of he vertical axis of the strap. The hook can be position on the holder to curve in the direction of an acute angle from the vertical axis of said strap.

### FIELD OF THE INVENTION

The present invention relates to fishing pole holders. More particularly, the present invention relates to fishing pole holders that strap onto the arms of individuals who fish.

### BACKGROUND

Fishing represents one of the most popular outdoor activities in the United States. In order to participate in most varieties of fishing, a fishing pole is requisite. While fishing, it is often necessary to rest one's pole due to fatigue. Additionally, the ability to use both hands to bait hooks, set lures, or to drink beverages, among other things, is often required. To address this problem, a method of holding the fishing pole, and freeing the hands is required.

A large number of devices to hold fishing poles have been conceived. However, many are over-complicated, requiring extensive care or assembly. Others can only be used on a motor vehicle or boat, eliminating their usability at many locations. Many lack ease of mobility. The current invention addresses these problems.

The following represents a list of known related art:

| Reference: | Issued to: | Date of Issue: |
|---|---|---|
| U.S. Pat. 6357639 | Williams | Mar. 19, 2002 |
| U.S. Pat. 3282482 | Scharsu | Nov. 1, 1966 |
| U.S. Pat. 5520312 | Maddox | May 28, 1996 |
| U.S. Pat. 1174319 | Hipwood | Mar. 7, 1916 |
| U.S. Pat. 3874573 | Fruscella et al. | Apr. 1, 1975 |
| U.S. Pat. 4569466 | Webber | Feb. 11, 1986 |
| U.S. Pat. 5386932 | Gross | Feb. 7, 1995 |
| U.S. Pat. 5511336 | Bishop | Apr. 30, 1996 |
| U.S. Pat. 5956883 | Krouth et al. | Sep. 28, 1999 |
| U.S. Pat. 6003746 | Richardson | Dec. 21, 1999 |
| U.S. Pat. 6138976 | Fahringer, Sr. | Oct. 31, 2000 |
| U.S. Pat. 1761497 | Smith | Jun. 3, 1930 |
| U.S. Pat. 6029872 | Ellington | Feb. 29, 2000 |
| U.S. Des. Pat. D489118 | Preiss | Apr. 27, 2004 |
| U.S. Pat. 6684555 | Vela | Feb. 3, 2004 |
| U.S. Pat. 6678991 | Hooks et al. | Jan. 20, 2004 |
| U.S. Pat. 6672559 | Boldia | Jan. 6, 2004 |
| U.S. Des. Pat. D458878 | Greco | Jun. 18, 2002 |
| U.S. Pat. 6341756 | Morris | Jan. 29, 2002 |
| U.S. Des. Pat. D448446 | Walls et al. | Sep. 25, 2001 |
| U.S. Pat. 6273391 | Engolia | Aug. 14, 2001 |
| U.S. Des. Pat. D434101 | Allen | Nov. 21, 2000 |
| U.S. Des. Pat. D431277 | Mitchell | Sep. 26, 2000 |
| U.S. Pat. 6088946 | Simmons | Jul. 18, 2000 |
| U.S. Des. Pat. D424658 | Mitchell | May 9, 2000 |
| U.S. Pat. 6050020 | Sizemore | Apr. 18, 2000 |
| U.S. Des. Pat. D413648 | Simpson et al. | Sep. 7, 1999 |
| U.S. Des. Pat. D405500 | Burby et al. | Feb. 9, 1999 |
| U.S. Des. Pat. D401999 | Huff | Dec. 1, 1998 |
| U.S. Des. Pat. D390627 | Waldman | Feb. 10, 1998 |
| U.S. Pat. 5625974 | Demaio | May 6, 1997 |
| U.S. Des. Pat. D374062 | Carter | Sep. 24, 1996 |
| U.S. Pat. 5542205 | Updike | Aug. 6, 1996 |
| U.S. Pat. 5533295 | Hochberger | Jul. 9, 1996 |
| U.S. Pat. 5491923 | Zingrone | Feb. 20, 1996 |
| U.S. Des. Pat. D360293 | Pierpoint | Jul. 18, 1995 |
| U.S. Des. Pat. D359817 | Leveika | Jun. 27, 1995 |
| U.S. Pat. 5400996 | Drish | Mar. 28, 1995 |
| U.S. Des. Pat. D356141 | Strong | Mar. 7, 1995 |
| U.S. Des. Pat. D356140 | Meyer et al. | Mar. 7, 1995 |
| U.S. Des. Pat. D349751 | Ruff | Aug. 16, 1994 |
| U.S. Des. Pat. D349555 | Siket, Jr. et al. | Aug. 9, 1994 |
| U.S. Pat. 5331761 | Kuthy | Jul. 26, 1994 |
| U.S. Des. Pat. D348301 | Smith | Jun. 28, 1994 |
| U.S. Pat. 5321904 | Benson | Jun. 21, 1994 |
| U.S. Des. Pat. D342301 | Lippstock | Dec. 14, 1993 |
| U.S. Pat. 5245778 | Gallegos et al. | Sep. 21, 1993 |
| U.S. Des. Pat. D337808 | Parker | Jul. 27, 1993 |
| U.S. Des. Pat. D335915 | Hoerl | May 25, 1993 |
| U.S. Des. Pat. D333176 | Millholen et al. | Feb. 9, 1993 |
| U.S. Des. Pat. D332821 | Padilla | Jan. 26, 1993 |
| U.S. Des. Pat. D329274 | Wilson | Sep. 8, 1992 |
| U.S. Des. Pat. D326704 | Calavan | Jun. 2, 1992 |
| U.S. Pat. 5076001 | Coon et al. | Dec. 31, 1991 |
| U.S. Pat. 5072539 | Greenberg | Dec. 17, 1991 |
| U.S. Pat. 5054228 | Elkins | Oct. 8, 1991 |
| U.S. Pat. 5014458 | Wagner | May 14, 1991 |
| U.S. Des. Pat. D313454 | Eglinsdoerfer, Sr. | Jan. 1, 1991 |
| U.S. Pat. 4969285 | Ellsworth et al. | Nov. 13, 1990 |
| U.S. Pat. 4925148 | Newton et al. | May 15, 1990 |
| U.S. Pat. 4920681 | Toliver, Jr. et al. | May 1, 1990 |
| U.S. Des. Pat. D307312 | Engle | Apr. 17, 1990 |
| U.S. Des. Pat. D307171 | Engle | Apr. 10, 1990 |
| U.S. Pat. 4901970 | Moss et al. | Feb. 20, 1990 |
| U.S. Pat. 4866873 | Van Valkenburg | Sep. 19, 1989 |
| U.S. Des. Pat. D303564 | Ewald | Sep. 19, 1989 |
| U.S. Pat. 4819903 | Jimenez | Apr. 11, 1989 |
| U.S. Pat. 4753029 | Shaw et al. | Jun. 28, 1988 |
| U.S. Pat. 4748762 | Campbell | Jun. 7, 1988 |
| U.S. Des. Pat. D295776 | Johansen | May 17, 1988 |
| U.S. Pat. 4739575 | Behrle | Apr. 26, 1988 |
| U.S. Pat. 4658534 | McLean | Apr. 21, 1987 |
| U.S. Pat. 4658533 | Mendoza | Apr. 21, 1987 |
| U.S. Pat. 4656774 | Terrill | Apr. 14, 1987 |
| U.S. Des. Pat. D287613 | Upton | Jan. 6, 1987 |
| U.S. Pat. 4603500 | Harrison, Sr. | Aug. 5, 1986 |
| U.S. Pat. 4550520 | Bogue | Nov. 5, 1985 |
| U.S. Pat. 4476645 | Paarmann | Oct. 16, 1984 |
| U.S. Pat. 4460117 | Smalls et al. | Jul. 17, 1984 |
| U.S. Des. Pat. D270080 | Culp | Aug. 9, 1983 |
| U.S. Des. Pat. D267031 | Hamlin | Nov. 23, 1982 |
| U.S. Pat. 4334337 | Hartwig | Jun. 15, 1982 |
| U.S. Pat. 4244132 | Hoffman et al. | Jan. 13, 1981 |
| U.S. Des. Pat. D255259 | Nelson | Jun. 3, 1980 |
| U.S. Pat. 4043531 | Green | Aug. 23, 1977 |
| U.S. Pat. 4040197 | Robbins | Aug. 9, 1977 |
| U.S. Pat. 4014128 | Hrdlicka | Mar. 29, 1977 |
| U.S. Pat. 4012861 | Gellatly | Mar. 22, 1977 |
| U.S. Pat. 3992798 | Schmitt, Sr. | Nov. 23, 1976 |
| U.S. Pat. 3973346 | Mason | Aug. 10, 1976 |
| U.S. Pat. 3945143 | Schmitt, Sr. | Mar. 23, 1976 |

The teachings of each of the above-listed citations (which does not itself incorporate essential material by reference) are herein incorporated by reference. None of the above inventions and patents, taken either singularly or in combination, is seen to describe the instant invention as claimed.

### SUMMARY AND ADVANTAGES

The armband fishing pole holder of the present invention helps to stabilize a fishing pole in use or while traveling with an individual. The armband fishing pole holder includes a strap which encircles the arm of an individual; and a hook attached to said strap. The holder can further include a fastening loop at one end of the strap. The holder can be provided with a buckle on end of the strap and hook and fastener material on an opposite end of the strap. The hook can be position on the holder to curve in the direction of he vertical axis of the strap. The hook can be position on the holder to curve in the direction of an acute angle from the vertical axis of said strap.

The armband fishing pole holder of the present invention presents numerous advantages, including: (1) easily portable in a tackle box or packet; (2) does not interfere with a user tying a lure or hook; (3) there are less hang ups for drift fisherman and faster hook setting when fish strike; (4) there is no give at the butt of pole providing less movement when setting the lure; (5) allows user to use one hand while playing the fish; (6) results in less fatigue when playing a big fish; (7) can be used with left or right hand; (8) assists in landing a fish when using a net by securing pole in hook; (9) does not interfere while casting; (10) can be used in a boat; and (11) can be used in Summer or Winter.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a perspective embodiment of the present invention in use.

FIG. 2 shows a side layout view of the embodiment of the present invention shown in FIG. 1.

FIG. 3 shows a top down layout view of the embodiment of the present invention shown in FIG. 1.

FIG. 4 shows a perspective of another embodiment of the present invention in use.

FIG. 5 shows a side layout view of the embodiment of the present invention shown in FIG. 4.

FIG. 6 shows a top down layout view of the embodiment of the present invention shown in FIG. 4.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

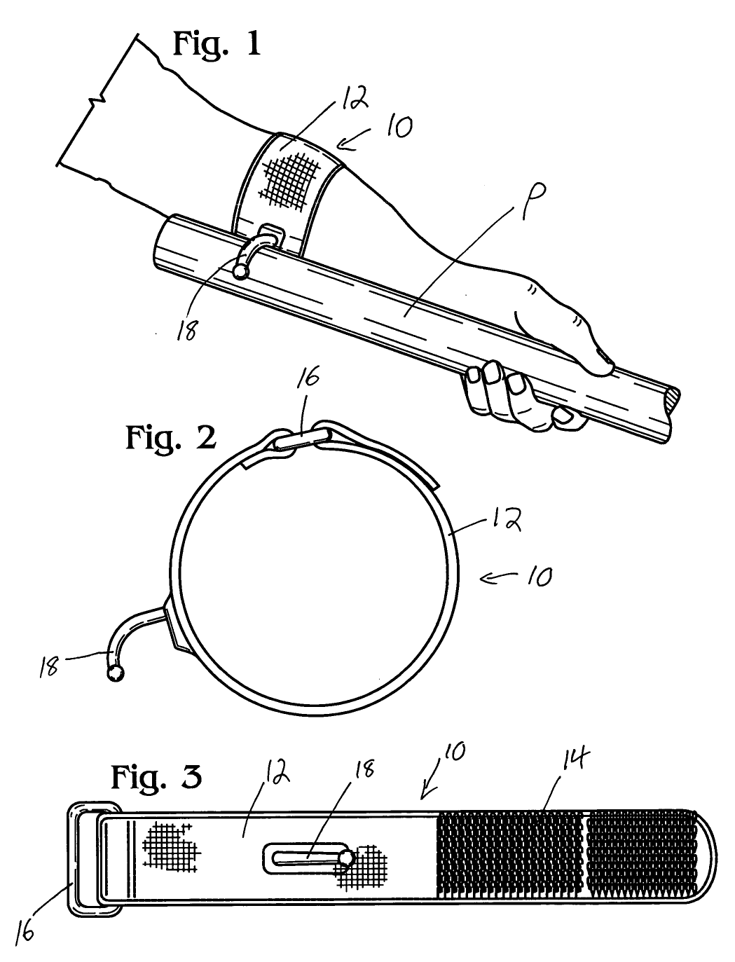

As shown in FIGS. 1-6, an armband fishing pole 10 is provided to support a fishing pole while in operation or during travel. As shown in FIGS. 1-3, an armband fishing pole 10 comprises a strap 12 that straps around the forearm of a fisherman and a hook 18 that holds a fishing pole down, preventing it from rising on a fish strike. Strap 12 in preferred embodiment is provided with a buckle 16 through which the strap is inserted, and strap then doubles back on itself, as shown in FIG. 2 and preferably attaches to itself in a hook and fastener style 14.

The strap 12 is of sufficient length to encircle a person's upper or lower arm. Buckle 16 attaches to strap 12 at one end, preferably doubling back on itself and sewn to secure the buckle to the strap, and contains an elliptical opening large enough for the distal end of the strap to pass through.

The hook 18 is preferably centrally located the horizontal axis of the strap. Hook 18 is semi-circularly shaped in the preferred embodiment, with a diameter large enough to accommodate all sizes of fishing poles. In the preferred embodiment, FIGS. 1-3, the armband fishing strap 10 is designed for use on the forearm such that the hook is curved in the direction of and along the vertical axis of the strap so that the band 10 when worn, see FIG. 1, presents the hook projecting out from the band and curved to the direction of the ground. Hook 18 is preferably attached to the strap 12 by sewing one end of the hook to the strap 12. Numerous ways to attach the hook to the strap are known to those skilled in the art.

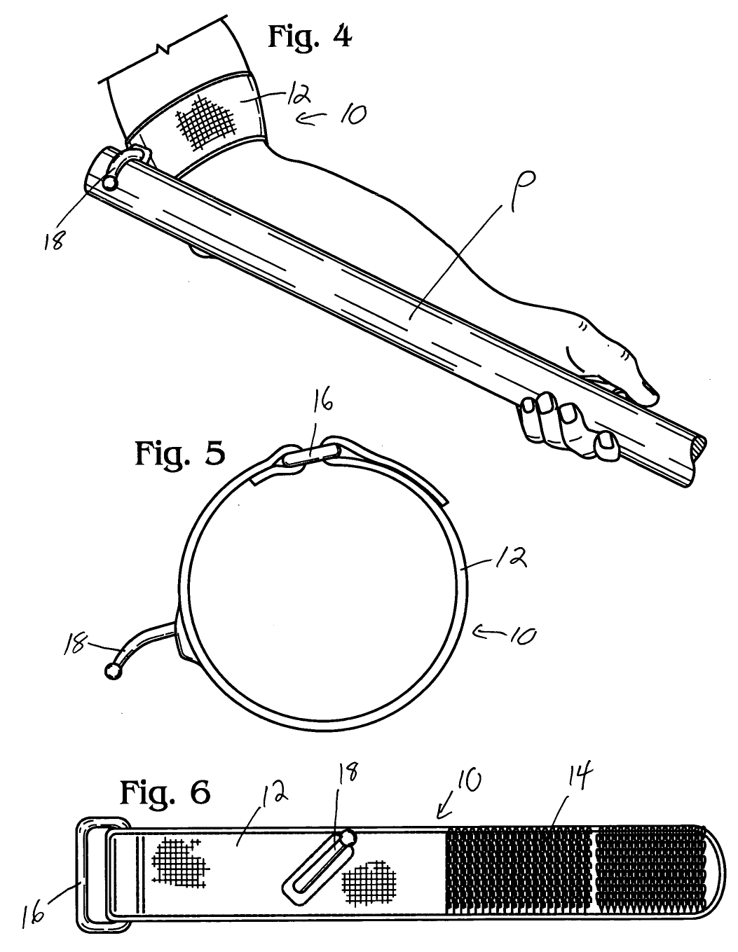

In an alternative embodiment, as shown in FIGS. 4-6, strap 12 is worn on the upper arm, above the elbow, and the hook 18 is attached to the strap 12 at an acute angle in relation to the vertical axis of the strap 12 such that when the strap 12 is worn, and the arm is bent, the hook 18 is again curved pointing toward the ground, as shown in FIG. 4.

Preferably, strap 12 is made of nylon material, having a section of hook and fastener material sown to end. Similarly, in the preferred embodiment, hook 18 is constructed from stainless steel. Potentially, other similar metals may be used in its construction.

In operation as shown in FIGS. 1-2, 4-5, the arm strap 10 wraps around the upper or lower arm, passes through the fastening loop, and fastens to itself using a hook and fastener style of connection 14. Fishing pole P is held in hand and end of pole is held down by the hook 18.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

1-5. (canceled)

6. An armband fishing pole holder, comprising:
a strap which encircles the arm of an individual with a fastening loop at one end of said strap; and
a hook attached to said strap, wherein said hook is curved in the direction of an acute angle from the vertical axis of said strap to allow the strap to be worn on the upper arm of the user.

7. An armband fishing pole holder, comprising:
a strap which encircles the arm of an individual with a fastening loop at one end of said strap; and
a hook attached to said strap, wherein a section of hook and fastener material is provided on one end of said strap and a buckle is provided on and opposite end of said strap, and said hook is curved in the direction of an acute angle from the vertical axis of said strap to allow the strap to be worn on the upper arm of the user.
